(19) United States
(12) Patent Application Publication
(10) Pub. No.: US 2020/0406866 A1
(43) Pub. Date: Dec. 31, 2020

(54) CAR WASH JUDGMENT SYSTEM AND CAR WASH JUDGMENT METHOD

(71) Applicant: TOYOTA JIDOSHA KABUSHIKI KAISHA, Toyota-shi (JP)

(72) Inventor: Kentaro ASAI, Toyota-shi (JP)

(73) Assignee: TOYOTA JIDOSHA KABUSHIKI KAISHA, Toyota-shi (JP)

(21) Appl. No.: 16/914,353

(22) Filed: Jun. 27, 2020

(30) Foreign Application Priority Data
Jun. 27, 2019 (JP) 2019-120289

(51) Int. Cl. B60S 3/04; G06K 9/00; B60W 60/00

(52) U.S. Cl. CPC B60S 3/04; G01C 21/3438; B60W 60/001; G06K 9/00791

(57) ABSTRACT

In a car wash judgment system, an acquirer acquires a captured image of a vehicle. An image analyzer analyzes the degree of dirt on a vehicle based on a vehicle image included in a captured image. A judgment unit judges whether or not the vehicle needs to be washed based on an analysis result from the image analyzer. The acquirer acquires a first captured image captured by a vehicle-mounted camera, and a second captured image captured by a mounted camera mounted on an object other than a vehicle. The image analyzer analyzes the degree of dirt on a vehicle based on a vehicle image included in the first captured image and the second captured image.

### BACKGROUND

### 1. Technical Field

The present disclosure relates to a technology for judging car wash timing of a vehicle.

### 2. Description of Related Art

JP-A-2015-219811 discloses a vehicle control system for allowing a vehicle parked in a parking lot to move out of there by automated driving. The vehicle control system allows a vehicle to move from a parking space to a standby area in a parking lot by automated driving, places the vehicle on standby in a standby order based on the scheduled leaving time set in advance, and allows, when an occupant of the vehicle arrives at an exit of the parking lot, the vehicle to move to the exit by automated driving. Also, when a vehicle is to be provided with a car wash service, the vehicle control system allows the vehicle to move to a washing position of an automatic car-washing machine and stop there.

Meanwhile, when an owner or a manager of a vehicle cannot notice or judge a state of the vehicle with a dirty outer surface, the car wash service cannot be sometimes provided at appropriate timing.

### SUMMARY

A general purpose of the present disclosure is to provide a technology for facilitating judgment on car wash timing of a vehicle.

In response to the above issue, a car wash judgment system according to one aspect of the present disclosure includes an acquirer configured to acquire a captured image of a vehicle, an image analyzer configured to analyze the degree of dirt on a vehicle based on a vehicle image included in a captured image, and a judgment unit configured to judge whether or not the vehicle needs to be washed based on an analysis result from the image analyzer.

Another aspect of the present disclosure is a car wash judgment method. The method includes acquiring a captured image of a vehicle, analyzing the degree of dirt on a vehicle based on a vehicle image included in a captured image, and judging whether or not the vehicle needs to be washed based on an analysis result from an image analyzer.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a diagram used to describe an overview of a car wash judgment system according to an embodiment;

FIG. 2 shows a functional configuration of the car wash judgment system according to the embodiment; and

FIG. 3 is a flowchart of car wash judgment processing according to the embodiment.

### DETAILED DESCRIPTION

An embodiment will now be described. The embodiment is illustrative and is not intended to be limiting.

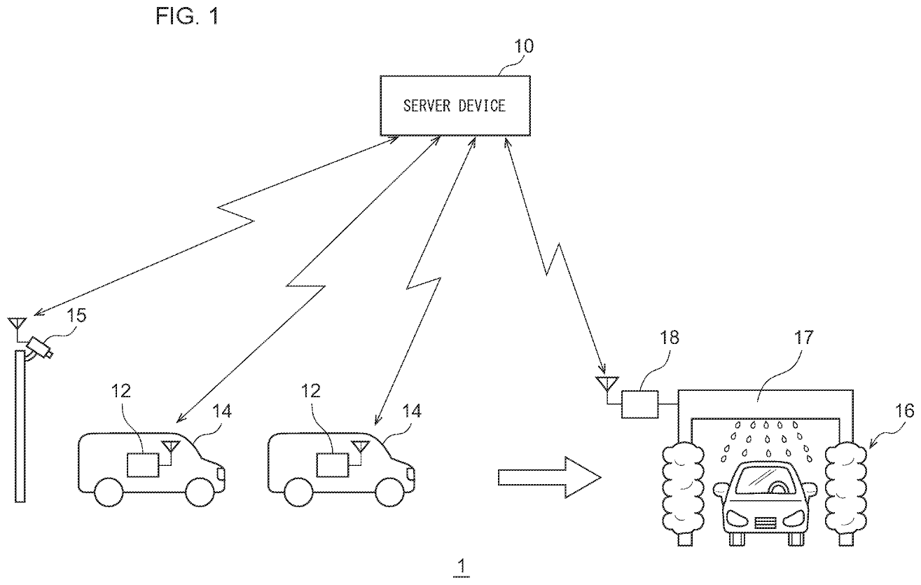

FIG. 1 is a diagram used to describe an overview of a car wash judgment system 1. The car wash judgment system 1 includes a server device 10, multiple automated driving vehicles 14, a mounted camera 15, and a car wash station 16. Each automated driving vehicle 14 has a wireless communication function and includes a vehicle-mounted device 12 connected to the server device 10 via a network, such as the Internet.

The number of automated driving vehicles 14 is not limited to two, and, in the car wash judgment system 1, a situation is assumed in which each of multiple automated driving vehicles 14 generates vehicle information and a captured image, and periodically transmits the vehicle information and captured image to the server device 10. The server device 10 is installed in a data center and receives the vehicle information and captured image transmitted from the vehicle-mounted device 12 of each automated driving vehicle 14.

Each automated driving vehicle 14 is capable of performing a manual driving mode in which the driver performs driving operations, and an automated driving mode in which the vehicle moves by automated driving. In the automated driving mode, the automated driving vehicle 14 can automatically move to the car wash station 16 according to an instruction signal from the server device 10. The automated driving vehicle 14 may also be used for car sharing.

The vehicle-mounted device 12 of each automated driving vehicle 14 includes a vehicle-mounted camera for capturing an image of the outside of the vehicle. The vehicle-mounted camera captures many other vehicles, and a captured image includes an image of another vehicle. The mounted camera 15 is provided in an object other than a vehicle. The mounted camera 15 is provided in at least one of a mobile terminal, an unmanned flying object, and a facility. For example, the mounted camera 15 may be installed in a facility in a parking lot to monitor the parked vehicles, or may be installed in an adjunct facility of a road at an intersection to monitor the vehicles traveling through the intersection.

The mounted camera 15 is provided with a communication unit 15a having a wireless communication function and connected to the server device 10 via a network, so as to be able to transmit a captured image to the server device 10. When the mounted camera 15 is mounted on a mobile terminal or an unmanned flying object, the communication unit 15a may transmit position information together with a captured image. The communication unit 15a also transmits identification information of the mounted camera 15 together with a captured image. When the mounted camera 15 is fixed to a facility, the position information of the mounted camera 15 is stored in advance in the server device 10.

In the car wash station 16, an actuation control device 18 is provided to control car wash equipment 17. The car wash equipment 17 washes a vehicle at a predetermined washing position. The actuation control device 18 has a wireless communication function and is connected to the server device 10 via a network. When an automated driving vehicle 14 is placed at the washing position of the car wash equipment 17, the actuation control device 18 actuates the car wash equipment 17. The actuation control device 18 may acquire, from the vehicle-mounted device 12 via the server device 10, information indicating that the automated driving vehicle 14 is placed at the washing position of the car wash equipment 17.

In the car wash judgment system 1, the server device 10 judges whether or not an automated driving vehicle 14 is to be washed based on a captured image, and, when determining that the car washing is to be performed, the server device 10 transmits a signal for ordering the car washing to the vehicle-mounted device 12. Upon reception of the signal for ordering the car washing, the vehicle-mounted device 12 performs control for moving the vehicle to the car wash station 16 to have the vehicle washed. Accordingly, car washing can be automatically performed at timing when a dirty outer surface of the automated driving vehicle 14 is detected.

When an automated driving vehicle 14 is used for car sharing, the server device 10 outputs an instruction signal for performing car washing after the use of car sharing is finished and before the next use is started. Accordingly, the automated driving vehicle 14 can be washed before it is provided to the next user. Also, since a manager of the car sharing service can judge the timing for car washing without actually checking the automated driving vehicle 14, the manager's time and effort can be saved.

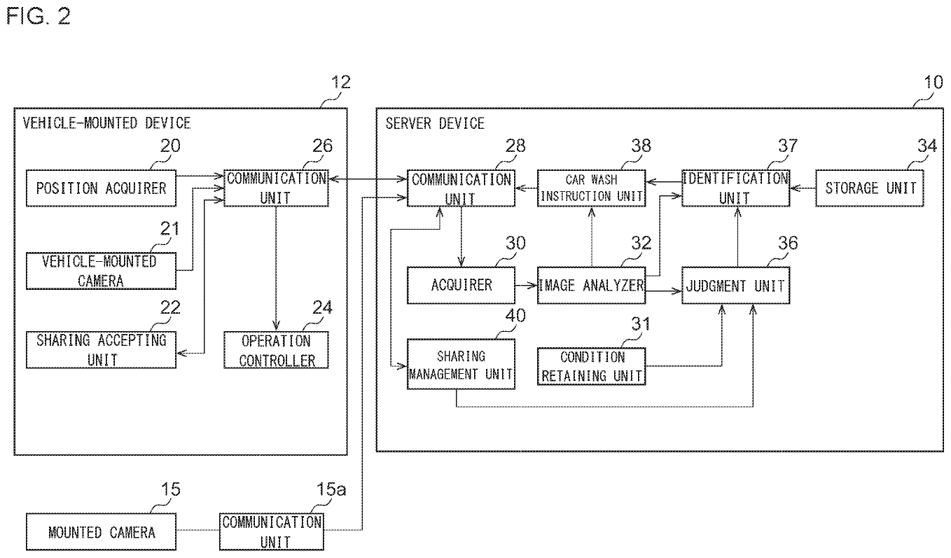

FIG. 2 shows a functional configuration of the car wash judgment system 1. Each of the elements represented by functional blocks for performing various processes shown in FIG. 2 can be implemented by a circuit block, a memory, an LSI or the like in terms of hardware, and by a program loaded into a memory or the like in terms of software. Accordingly, it will be obvious to those skilled in the art that these functional blocks may be implemented in a variety of forms by hardware only, software only, or a combination thereof, and the form is not limited to any of them.

The vehicle-mounted device 12 includes a position acquirer 20, a vehicle-mounted camera 21, a sharing accepting unit 22, an operation controller 24, and a communication unit 26. The server device 10 includes a communication unit 28, an acquirer 30, a condition retaining unit 31, an image analyzer 32, a storage unit 34, a judgment unit 36, an identification unit 37, a car wash instruction unit 38, and a sharing management unit 40.

The position acquirer 20 of the vehicle-mounted device 12 acquires position information of the vehicle and the time of the acquisition of the position information, and transmits the information and time to the server device 10 via the communication unit 26. The position information of the vehicle may be latitude and longitude acquired using a global positioning system (GPS). By chronologically following the position information of the vehicle, the traveling direction of the vehicle can be obtained.

The vehicle-mounted camera 21 includes a front camera and a rear camera to generate captured images of an area in front of the vehicle and an area in the rear of the vehicle. To a captured image, the image capture time and the image capture direction, which is either the forward direction or the rearward direction of the vehicle, are related.

The sharing accepting unit 22 accepts use of car sharing. The sharing accepting unit 22 retains in advance authentication information of users, and, upon acceptance of identification information from a user, the sharing accepting unit 22 performs matching between the authentication information and identification information to perform authentication. When the authentication is successful, the sharing accepting unit 22 permits the use of car sharing. The sharing accepting unit 22 also accepts termination of use of car sharing from a user. The start time and finish time of use of car sharing are transmitted to the server device 10 via the communication unit 26. For example, a user may make a reservation of an automated driving vehicle 14 in advance, input the identification information to the sharing accepting unit 22 to start the use of the automated driving vehicle 14, and input the identification information to the sharing accepting unit 22 to finish the use of the automated driving vehicle 14. The automated driving vehicle 14 may be parked in a predetermined parking lot when use of the automated driving vehicle 14 is started and finished. The sharing accepting unit 22 may receive the identification information of a user from an IC card or a mobile terminal held by the user. The processing of user authentication may also be performed in the server device 10, and, in this case, the server device 10 receives the identification information of the user from the vehicle-mounted device 12 and performs authentication processing at the sharing management unit 40.

The operation controller 24 automatically performs driving operations for acceleration, steering, and braking in the automated driving mode to drive the vehicle. The operation controller 24 drives the vehicle along a targeted traveling route set in advance. The targeted traveling route defines a route from the current position to a destination, and the targeted traveling route from the parking lot to the car wash station 16 may be derived by the server device 10.

The communication unit 26 transmits, to the server device 10, the position information of the vehicle, the time of acquisition of the position information, a captured image from the vehicle-mounted camera 21, the image capture time, the image capture direction, and information regarding use of car sharing, with a vehicle ID attached thereto. The communication unit 26 may also transmit, to the server device 10, information indicating the traveling direction of the vehicle generated based on the position information of the vehicle.

The acquirer 30 of the server device 10 acquires, via the communication unit 28, a captured image of the vehicle, the image capture time, the image capture direction, the position information of the vehicle, and the time of acquisition of the position information. The acquirer 30 acquires a first captured image captured by the vehicle-mounted camera 21, and a second captured image captured by the mounted camera 15 mounted on an object other than a vehicle. The acquirer 30 can acquire a position at which an image is captured, based on the image capture time of the captured image and the time of acquisition of position information. When the first captured image and the second captured image are not differentiated from each other, they may be simply referred to as captured images.

The sharing management unit 40 manages use of car sharing. The sharing management unit 40 accepts a reservation of an automated driving vehicle 14 from a user. The sharing management unit 40 also acquires the start time and finish time of use input to the sharing accepting unit 22.

The image analyzer 32 analyzes the degree of dirt on a vehicle based on a vehicle image included in at least one of the first captured image and the second captured image. The image analyzer 32 derives, as the degree of dirt on the vehicle, the degree of dirt on the vehicle body, the degree of dirt on the wheels, and the degree of dirt on the windows. The image analyzer 32 detects dotted or ripple-like filmy dirt due to stains caused by rain or adhesion of yellow dust, streaky stains formed such that they look like flowing down, and adhesion of mud, for example, and derives the degree of dirt on each part based on the area and the boldness of the dirt. The image analyzer 32 may use a neural network method to learn states of dirt including dotted filmy dirt, streaky stains formed such that they look like flowing down, and adhesion of mud, learn the levels of the states of dirt, and classify a state of dirt in a vehicle image as one of multiple levels using the learned results to derive the degree of dirt. The degrees of dirt on a vehicle may only include “0” indicating that car washing is unnecessary, and “1” indicating that car washing is necessary.

The image analyzer 32 extracts vehicle identification information from a vehicle image. The vehicle identification information is information for identifying each vehicle image and may be a registration number shown in a license plate or an identification mark shown on a vehicle body. The vehicle identification information may include feature information of the vehicle, such as the vehicle type, the vehicle color, and the traveling direction in the vehicle image. The traveling direction in the vehicle image is derived based on the image capture direction of the captured image and the forward and rearward directions of the vehicle indicated in the vehicle image.

Based on the analysis result from the image analyzer 32, the judgment unit 36 judges whether or not the vehicle needs to be washed. The timing at which the judgment unit 36 performs such car wash judgment processing may be set between the finish time of use and the start time of the subsequent use of car sharing. Accordingly, the judgment unit 36 performs the car wash judgment processing before the next user starts the use of the automated driving vehicle 14.

When the degree of dirt on a vehicle derived at the image analyzer 32 satisfies a predetermined car wash condition, the judgment unit 36 judges that the vehicle needs to be washed. When the degree of dirt on a vehicle does not satisfy the predetermined car wash condition, the judgment unit 36 judges that car washing is unnecessary.

The predetermined car wash condition is retained in the condition retaining unit 31. The predetermined car wash condition is satisfied when at least one of the degree of dirt on the vehicle body, the degree of dirt on the windows, and the degree of dirt on the wheels exceed a predetermined car wash threshold. Also, the predetermined car wash condition may be satisfied when each of at least two of the degree of dirt on the vehicle body, the degree of dirt on the windows, and the degree of dirt on the wheels exceeds the predetermined car wash threshold. The predetermined car wash threshold may be set differently for each of the degree of dirt on the vehicle body, the degree of dirt on the windows, and the degree of dirt on the wheels.

The predetermined car wash condition may include the condition of washing the vehicle in time for the next use of car sharing. More specifically, when it is indicated that the total time of transit time required for the moving to the car wash station 16 and moving to a predetermined parking lot by an automated driving vehicle 14 and car wash time required for the car washing by the car wash equipment 17 can be secured before the start time of the next use of car sharing, the judgment unit 36 judges that one car wash condition is satisfied, and, when it is indicated that the total time of the transit time and the car wash time cannot be secured before the start time of the next use, the judgment unit 36 judges that the one car wash condition is not satisfied. Based on the information regarding use of car sharing from the sharing management unit 40, the judgment unit 36 acquires the finish time of the use of car sharing and the start time of the next use. The start time of the use may be the time for which the reservation of the start of use has been made by the user. In this way, the judgment unit 36 judges whether or not an automated driving vehicle 14 needs to be washed before use of the automated driving vehicle 14 is started.

An identification unit 37 identifies an automated driving vehicle 14 by confirming that the vehicle identification information extracted at the image analyzer 32 corresponds to vehicle identification information stored in the storage unit 34. The storage unit 34 stores the vehicle identification information of automated driving vehicles 14. Accordingly, an automated driving vehicle 14 that satisfies a predetermined car wash condition can be identified. The vehicle to be identified may not necessarily be limited to an automated driving vehicle 14.

The identification of a vehicle is not limited to that based on the registration number, and the identification unit 37 may also identify a vehicle using multiple pieces of information, including the vehicle type, the vehicle color, the traveling direction of the vehicle, and the position information of the vehicle. Since the server device 10 collects the position information of vehicles and image capture position information, the identification unit 37 can recognize a vehicle positioned around an area included in a captured image and the traveling direction of the vehicle, and identify the vehicle based on whether or not the vehicle type, the vehicle color, and the traveling direction in the vehicle image included in the captured image coincide with vehicle identification information stored in the storage unit 34.

When it is judged that an automated driving vehicle 14 needs to be washed, the car wash instruction unit 38 transmits, to the corresponding vehicle-mounted device 12, an instruction signal for moving the automated driving vehicle 14 to the car wash station 16. When the vehicle that has received the instruction signal is an automated driving vehicle 14, the automated driving vehicle 14 moves to a washing position in the car wash station 16 and then moves from the car wash station 16 to a predetermined parking lot to be parked there according to automated driving control performed by the operation controller 24.

When the automated driving vehicle 14 is used for car sharing, the car wash instruction unit 38 transmits an instruction signal for moving the automated driving vehicle 14 to the car wash station 16 before use of the automated driving vehicle 14 is started, so that the car washing can be performed in time for the next use of car sharing.

For a vehicle for manual driving, which is not an automated driving vehicle 14, the car wash instruction unit 38 transmits information for ordering car washing to the vehicle-mounted device 12 of the vehicle, and the vehicle-mounted device 12 notifies the driver to wash the vehicle.

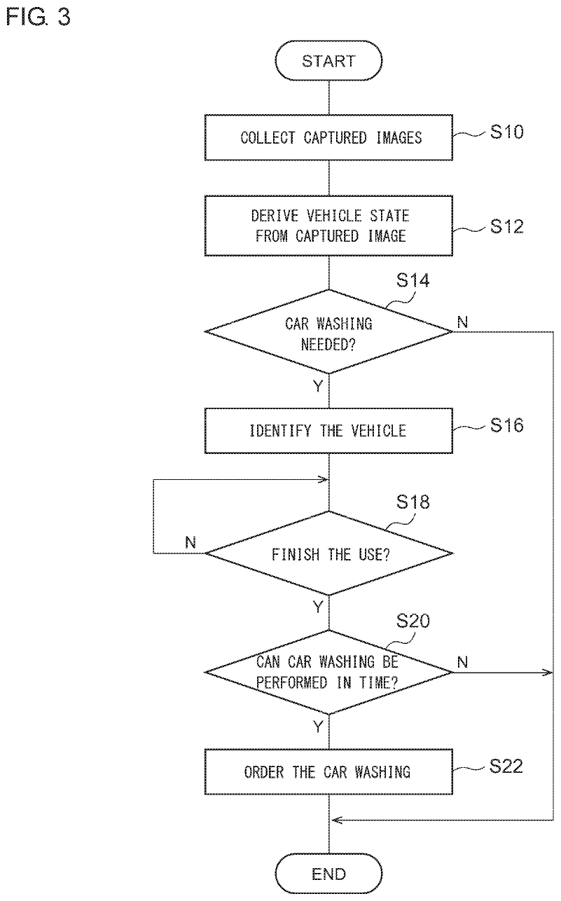

FIG. 3 is a flowchart of the car wash judgment processing. The acquirer 30 of the server device 10 collects captured images from the vehicle-mounted camera 21 and the mounted camera 15 (S10). The image analyzer 32 derives the degree of dirt on an automated driving vehicle 14 from a vehicle image included in a captured image (S12).

Based on the analysis result from the image analyzer 32, the judgment unit 36 judges whether or not the automated driving vehicle 14 needs to be washed (S14). When the degree of dirt on the automated driving vehicle 14 does not satisfy a predetermined car wash condition (N at S14), car washing is unnecessary, and the processing is terminated.

When the degree of dirt on the automated driving vehicle 14 derived at the image analyzer 32 satisfies a predetermined car wash condition, the judgment unit 36 judges that the automated driving vehicle 14 needs to be washed (Y at S14). The identification unit 37 identifies the automated driving vehicle 14 by confirming that the vehicle identification information in the vehicle image extracted at the image analyzer 32 corresponds to vehicle identification information stored in the storage unit 34 (S16).

Until the sharing accepting unit 22 accepts the termination of the use of car sharing (N at S18), the sharing management unit 40 monitors the use condition of the automated driving vehicle 14. When the sharing accepting unit 22 accepts the termination of the use of car sharing (Y at S18), the sharing management unit 40 receives the finish time of the use from the sharing accepting unit 22 and transmits the finish time to the judgment unit 36. The judgment unit 36 judges whether or not washing the automated driving vehicle 14 can be finished by the start time of the next use of car sharing (S20).

When the wash of the automated driving vehicle 14 cannot be finished by the start time of the next use of car sharing (N at S20), the processing is terminated without ordering the car washing. In this case, a car wash flag may be set for the automated driving vehicle 14, and the car wash instruction unit 38 may order the car washing when the next use of car sharing is finished.

When the wash of the automated driving vehicle 14 can be finished by the start time of the next use of car sharing (Y at S20), the car wash instruction unit 38 judges that a predetermined car wash condition is satisfied and transmits an instruction signal for moving the automated driving vehicle 14 to the car wash station 16. Upon reception of the instruction signal, the operation controller 24 of the automated driving vehicle 14 automatically moves the automated driving vehicle 14 to the car wash station 16 and moves, when the car washing is finished, the automated driving vehicle 14 from the car wash station 16 to a predetermined parking lot. Thus, when an outer surface of a vehicle is presumed to be dirty and also when the vehicle can be washed in time for the next use of car sharing, the car washing is ordered. Accordingly, the automated driving vehicle 14 with the outer surface in a favorable state can be provided to a car sharing user.

The embodiment is intended to be illustrative only, and it will be obvious to those skilled in the art that various modifications to a combination of constituting elements could be developed and that such modifications also fall within the scope of the present disclosure.

Although the embodiment describes a mode in which the vehicle is an automated driving vehicle 14 used for car sharing, the mode is not limited thereto, and it may be a vehicle for manual driving owned by an individual. In this case, the server device 10 performs the car wash judgment processing based on a captured image including a vehicle image, and, when a car wash condition is satisfied, the server device 10 identifies the vehicle and provides, to the vehicle-mounted device 12, a notification indicating that car washing should be performed.

What is claimed is:

1. A car wash judgment system, comprising:
an acquirer configured to acquire a captured image of a vehicle;
an image analyzer configured to analyze the degree of dirt on a vehicle based on a vehicle image included in a captured image; and
a judgment unit configured to judge whether or not the vehicle needs to be washed based on an analysis result from the image analyzer.

2. The car wash judgment system according to claim 1, wherein
the acquirer acquires a first captured image captured by a vehicle-mounted camera, and
the image analyzer analyzes the degree of dirt on a vehicle based on a vehicle image included in the first captured image.

3. The car wash judgment system according to claim 1, wherein
the acquirer acquires a second captured image captured by a mounted camera mounted on an object other than a vehicle, and
the image analyzer analyzes the degree of dirt on a vehicle based on a vehicle image included in the second captured image.

4. The car wash judgment system according to claim 1,
wherein the image analyzer extracts vehicle identification information from a vehicle image,
the car wash judgment system further comprising:
a storage unit storing vehicle identification information of an automated driving vehicle;
an identification unit configured to identify the automated driving vehicle by confirming that the vehicle identification information extracted at the image analyzer corresponds to vehicle identification information stored in the storage unit; and
a car wash instruction unit configured to transmit, when it is judged that the automated driving vehicle identified at the identification unit needs to be washed, an instruction signal for moving the automated driving vehicle to a car wash station.

5. The car wash judgment system according to claim 4, wherein
the automated driving vehicle is used for car sharing,
the judgment unit judges whether or not the automated driving vehicle needs to be washed before use of the automated driving vehicle is started, and,
when it is judged that the automated driving vehicle needs to be washed, the car wash instruction unit transmits an instruction signal for moving the automated driving vehicle to a car wash station before use of the automated driving vehicle is started.

6. A car wash judgment method, comprising:
acquiring a captured image of a vehicle;
analyzing the degree of dirt on a vehicle based on a vehicle image included in a captured image; and
judging whether or not the vehicle needs to be washed based on an analysis result.
